(19) United States
(12) Patent Application Publication
(10) Pub. No.: US 2008/0215451 A1
(43) Pub. Date: Sep. 4, 2008

(54) StreamSale distribution model

(76) Inventor: Aaron Michael Abbott, Atlanta, GA (US)

Correspondence Address: Aaron M. Abbott, 18 White Foord Avenue NE, Atlanta, GA, 30307, US

(21) Appl. No.: 11/899,478

(22) Filed: Jan. 28, 2008

Related U.S. Application Data
(60) Provisional application No. 60/844,702, filed on Sep. 15, 2006.

(51) Int. Cl. G06Q 30/00

(52) U.S. Cl. 705/26

(57) ABSTRACT

As the Internet becomes more and more a part of our everyday lives, we see new Business Models evolve from existing Industry Business Practices. The StreamSale Distribution Model has the ability to generate Hundreds of Millions of Dollars (US) with one 60-minute broadcast. By selling an experience via the Internet, with an added feature, a unique business model emerges. Once implemented and marketed, competition will ultimately copy and implement this model. This is the very need for Patent Protection. This creates a paradigm shift in the way an Industry sells their primary products. These products, rather than remaining only tangible, are given experiential value. In fact, the customer will receive the tangible products, but for free. People have always been willing to pay for live entertainment, and continually exhibit the enjoyment of and are drawn to the evolving Internet streaming experience. This is how this inventive business model was created.

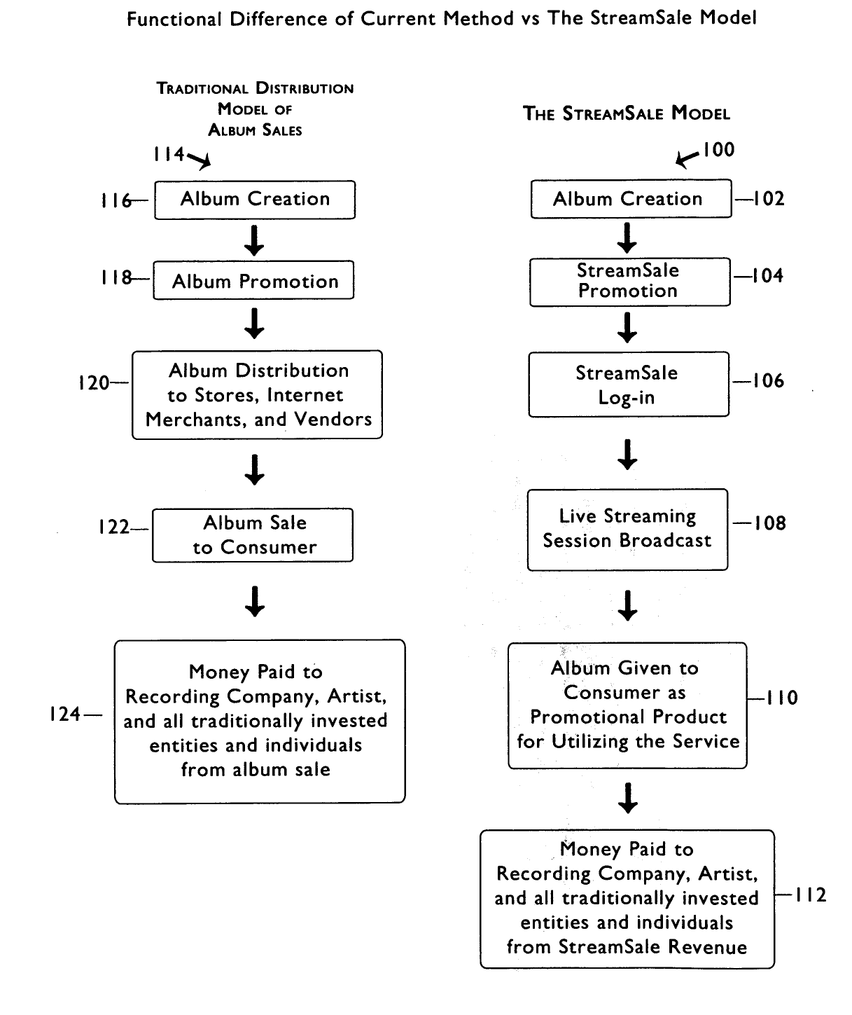

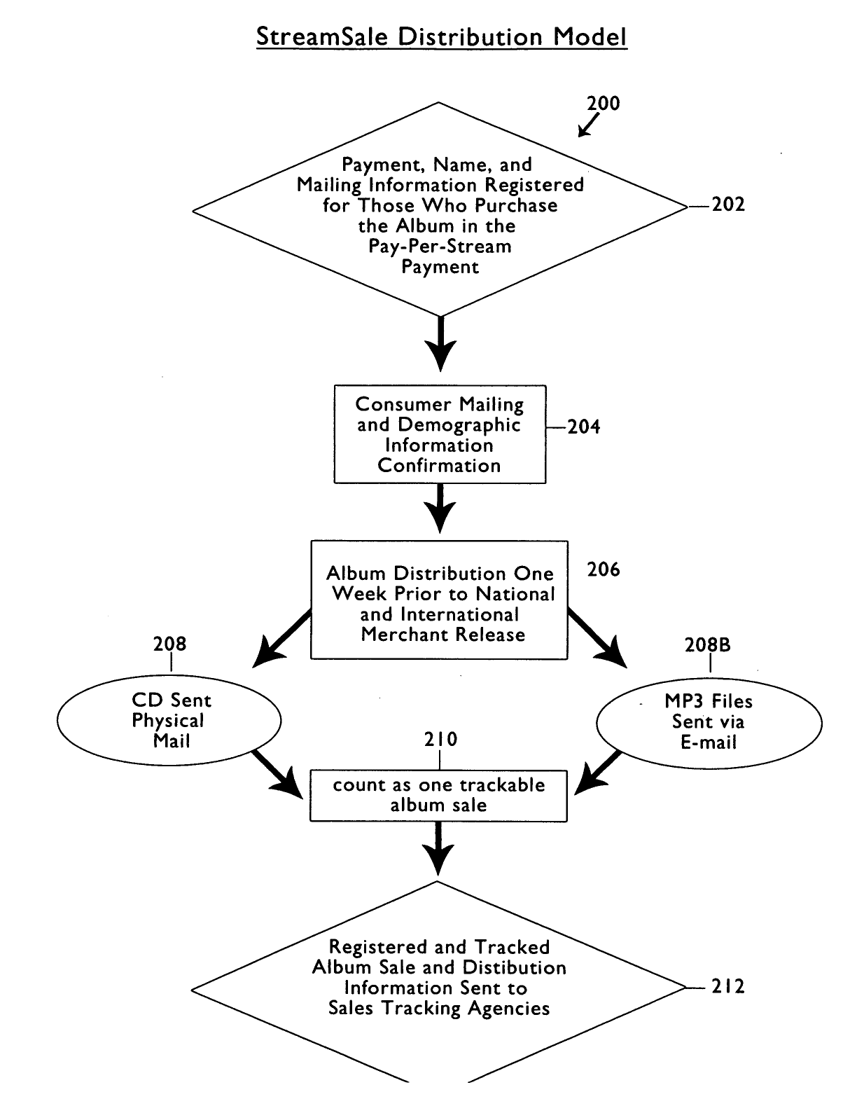

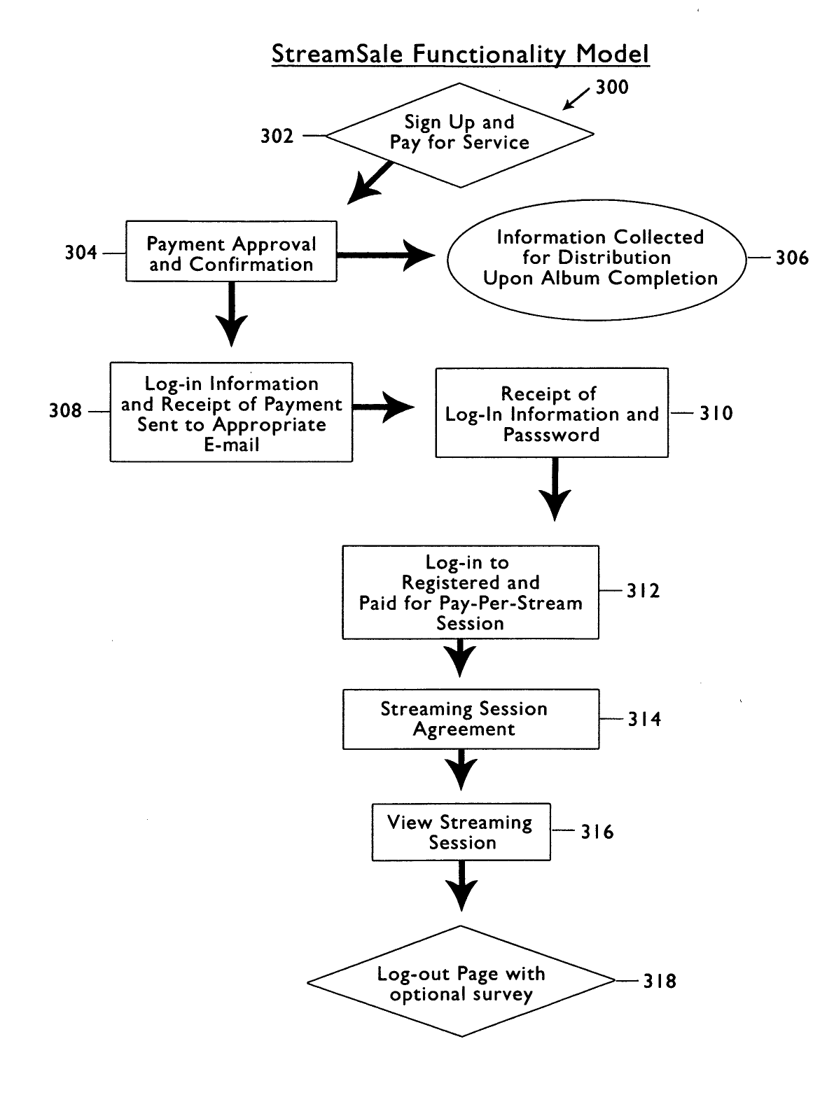

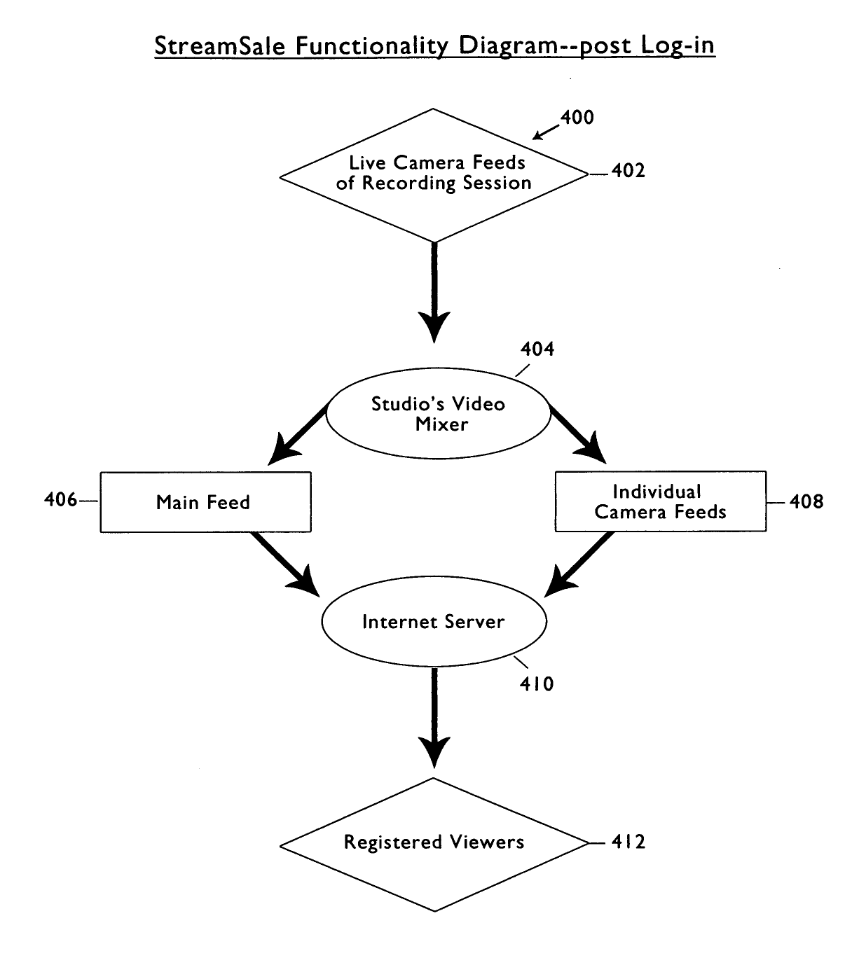

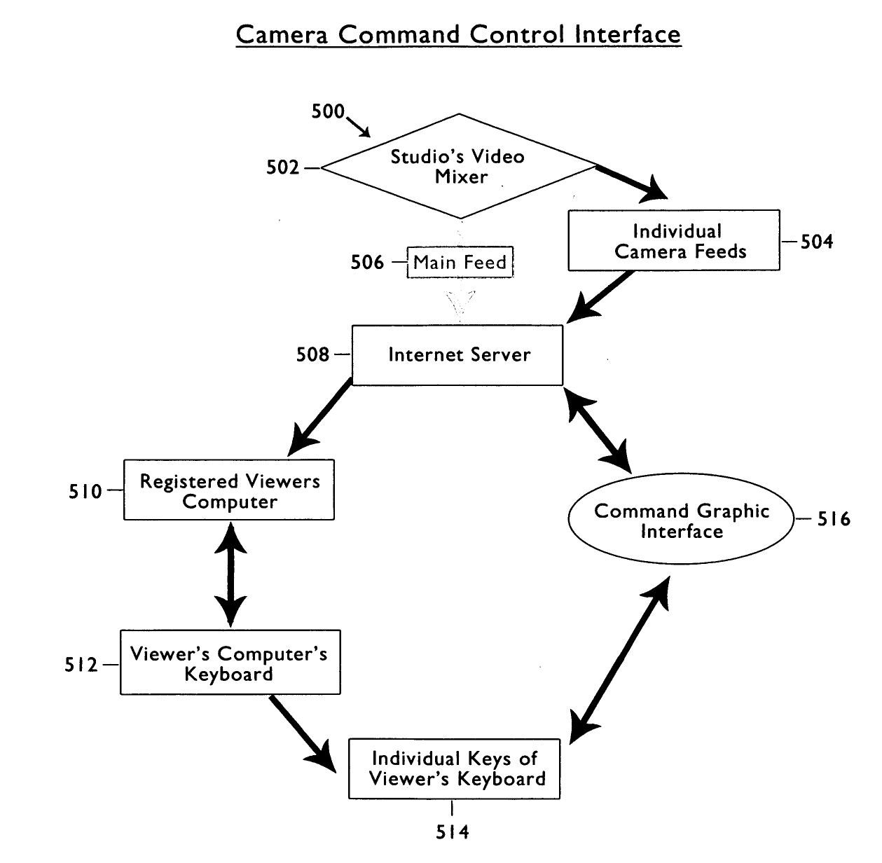

### DESCRIPTION OF DIAGRAMS

### Diagram 100:

It is shown in this diagram the functional difference between the StreamSale Distribution Model and the traditional methodologies of album sales. You can see the functional differences in the process between markers 104 thru 110 and 118 thru 122. The StreamSale Distribution Model is allowing the consumer to purchase another directly related service, in lieu of purchasing the album directly. By paying and agreeing to view the live streaming session of the Recording Session or Concert, with the intent of receiving the completed album for this purchase, both processes end at the same end-result, shown at markers 112 and 124.

### Diagram 200:

Diagram 200 shows how the StreamSale Distribution Model will actually work as a distribution model, supplying the album to the consumer. The diagram shows how album sales are tracked and how the necessary tracking information will be given to the necessary organizations, bodies, and agencies. This would be just like the owner of a traditional record store accounting for how many compact discs, vinyl albums, or tapes were sold. The actual count for tracking purposes will occur at marker 210, when the physical copy of the album is sent to the consumer.

### Diagram 300:

Diagram 300 shows the methodology of the consumer utilizing the StreamSale Distribution Model to see their favorite artist's live recording sessions or concerts of the album the are going to purchase or steal when it is available. Consumers will be able to sign up for their StreamSale session once the session is scheduled in our studios. At this point, when the registration is confirmed at marker 308, this information will be stored until the actually login to view the session at marker 312.

### Diagram 400:

Diagram 400 shows the consumer's experience once they login to view their paid for StreamSale experience. This shows the actual flow of the cameras recording the footage to the consumer's display monitor attached to their computer. Marker 406 shows how an in-house mix of the streaming video will be available, while at the same time, marker 408 shows how our consumers will be able to view individual feeds for each camera at their control. This will allow a fan who loves to watch the drummer, to single out the drummer if they wish.

### Diagram 500:

Diagram 500 actually breaks down what Marker 408 shows-access to individual feeds. As a part of this process, the users experience is of utmost importance. Allowing them to see what they want to see is vital. Between Marker 508 and Marker 516, we see a cycle of information. This cycle actually shows how the consumer will be able to control these individual feeds, from the studios cameras, to see which ever angle, view, or shot they prefer to see. With the installation of a software application, which will be StreamSale software, the consumer will actually be able to choose a camera feed with the push of the keys on their computer's keyboard.

Music fans will pay to view their favorite artists, producers, musicians, disc jockeys, etc., live via Internet streaming, to their laptop, desktop PC, mobile electronic and data storage/access devices, etc., recording the album in actual live recording sessions, or on promotional concert tours for the sale of the album that they will otherwise be purchasing from the artist or company. The reason they will pay to view the live streaming video of these recording sessions and concert promotions is that the consumer will receive the album/production for free, when it is released, because they paid for and viewed the exclusive StreamSale live video streaming session. Because they purchase the live StreamSale session, with the intent to receive the album, we can count the purchase as a tracked album sale. This fulfills Music Industry needs to track and count the number of albums an artist sells. By giving the consumer a new vehicle to purchase the music albums they wish to purchase, we are able to combat declining sales as a result of illegal piracy via the Internet. Whether or not they want to illegally download the music from a file sharing company, or burn a copy of their friend's CD, they will not be able to watch the actual StreamSale session, live, without paying for the streaming experience that gives them the album as part of the purchase. They are indirectly purchasing a product they were otherwise stealing, by paying for a different service. It is this service, the viewing experience, which allows the consumer to purchase the music production via paying for the StreamSale live video streaming experience that warrants patent protection. This is a unique and original business model that functions as a unique and exclusive Internet Distribution Model that will directly impact the Music Industry in regards to illegal piracy and declining CD sales.

### FIELD OF THE INVENTION

The Invention relates directly to the distribution of music by Major and Independent Record Labels, Companies, and Studios. While many of the major companies of the Recording Industry struggle to resolve the decline of Compact Disc and Album sales of their artists, the StreamSale Distribution Model is the solution. The problem is two tiered:

1) The rise in illegal downloading and file sharing of music, and

2) A consumer shift to the electronic purchase of albums via the Internet.

The result has been a major loss in revenues the Industry has traditionally seen from direct CD sales. We now see a more complex procedure for tracking album sales, as many fans may now elect to purchase their music, on a song-by-song basis. The StreamSale Distribution Model attaches the traditional CD Album Sale as a part of another service that fans will pay for. This service will be the live viewing of one of the recording sessions and/or concerts, where the particular album is being recorded or promoted. No other company is executing business practices in said manner, and this is the unique distribution and business model that will increase the sale of albums by providing the consumer with a new and unique experience that can track the purchased album via the StreamSale experience.

The reason the StreamSale Distribution Model is important, is not just for the sake of the profit of the Industry and the Artist, it is for the experience of the fan as well. For one, many fans do not get the printed booklets, which come as a part of the CD package. This in itself costs jobs for manufacturing and printing plants as well as for graphic artists. As well, CD audio quality far surpasses that of the monopolizing MP3, and the like, file formats that are now on top as the highest purchased file formats. Just look at the success of Apple's iPod, a portable handheld MP3 player, which is the hub for the sale of Apple's AAC music file type. The AAC is Apple's version of the MP3. The only reason these types of files are so popular is because of current data storage limitations. Current technology allows only a certain amount of storage space on programmed, handheld storage devices, such as the iPod, which is essentially a portable hard drive, programmed with a media player application. As new technologies emerge in the field of data storage, such as holographic optical storage drives, we will be able to once again enjoy the high quality of uncompressed audio file formats, such as that found on the CD Album. The StreamSale Distribution Model represents an entirely new and fresh modality of distribution for music and the experience itself. When technology allows, you will see consumers drop MP3s like a bad habit and look for new, and exciting avenues to purchase those high quality files for their new 100,000 GB Handheld Portable Entertainment and Media Player Device. Time will disclose this course, as the StreamSale Distribution Model merely prepares for Industry shifts and trends. This concept represents a new sales and promotion vehicle for any artist, and/or their contractual affiliates, who sell their creative productions to their fans.

Equally, this original method has the ability to generate tremendous amounts of money in very short periods of time. For arguments sake, let's say the Rolling Stones were broadcasting via a live StreamSale Event to sell their new album. Now let's say the rate for the event is $20.00 US dollars per viewer. Each one agrees that they have logged in to the event to purchase the album when it is completed. Let's now say 500,000 fans log into the live broadcast. This, being a StreamSale Recording Session, results in generating $10,000,000.00 dollars US before the event is even broadcasted or the album has even been completed. This is unheard of in the traditional and current practices of the Music and Entertainment Industries. Yes, many companies are streaming the music and video experience. However, none are utilizing the streaming experience as a distribution model for the sale of the album/production. Once we do, they will follow suit, necessitating patent protection.

### SUMMARY OF THE INVENTION

The experience itself is simple. The advancements technology and business provide, are something we are getting more accustomed to. As people begin to understand what it all means, and how to use the emerging products and services, we discover new sales vehicles, new virtual store fronts, and a new global marketplace. This marketplace is the medium of transmission and communication that allows the individual business minded person to broadcast their mission statement and product, right along the most powerful corporate conglomerate. By now, most everyone has watched video via the Internet. Whether or not you have watched a live broadcast of an event or searched archives of video to find something, just like you would on the current standing www.YouTube.com, we are beginning to understand the power of the Internet and what the video and moving picture experience means to the Internet. As well as witnessing the effect on business practices, globally. The Internet represents new businesses, new business tactics, and new experiences, which evolve exponentially day by day. While some view illegal piracy of music via the Internet as a challenge and a source of declining profit margins, those of us who look to the future see nothing but a challenge that once understood, becomes pure opportunity.

This opportunity is to shift the traditional practices of an Industry that has taken the essence of creativity out of its products and replaced it by objectifying marketability as the most important aspect of the creative production. Not only does the StreamSale Distribution Model provide solutions to existing Industry problems, as well as providing new experiences for the consumer; the StreamSale Distribution Model creates a direct link between artists and fans, and will ultimately bring creativity and originality back to the Industry. How many people are going to want to buy that Pop Star whose voice really isn't that good? In a sense, the StreamSale Distribution Model puts our artists in the hot seat, having to show their fans what they are really about, and where their talent truly lays. The method is something the Industry has not even shown a glimpse of utilizing as a business strategy. Once implemented, it is predicted that they will follow suit and want to utilize our strategies for their profit purposes. This is the unique and original nature of the StreamSale concept that needs and warrants protection.

The emergence of the digital music revolution calls for a new business model that will stimulate and stabilize sales of commercially released music albums. The Music Industry has seen a consistent problem in stimulating, and even maintaining consistent album sales, due to the illegal piracy of music via the Internet. Illegal downloading of music has resulted in a decline in overall CD sales. The Music Industry, necessarily, seeks a new business model that will secure the rights of artists and record companies to profit from their original creative productions for commercial release and profit. The StreamSale Distribution Model is an original and unique business model that generates a new source of income for the Music Industry that will replace the need; to sell the album by the traditional means, of in-store and Internet based sales.

This new method and process generates a variety of results that are unique and original to the current model of album sales practiced by the Music Industry. When the StreamSale Distribution Model is utilized, existing companies will change their methodologies and rely on this process for this source of revenue, which has traditionally been generated from in-store, mail order, peer-to-peer, and Internet album sales. This process actually allows the company to give the CD away, as a promotional product. The consumer will purchase another service, in lieu of purchasing the album itself, giving the same end result of purchase with added consumer benefits. The StreamSale Distribution Model is like a turbo charged car. We are taking the CD and adding consumer benefits and providing experience to the product. Not one company to date has attempted to conduct business with combined promotion in this manner. Once they see it in action they will jump out of their sea of struggle and try to do what we are doing. The purchase of this service, with the knowledge that you will receive the album will not interfere with the need to chart album sales. It will actually help. After the payments are confirmed and albums are sent to the consumer, StreamSale will notify all Music Industry Companies and Affiliates who utilize this database information. The purchase of an album and the purchase of a StreamSale broadcast recording session, as a vehicle to sell an album, hold the same intrinsic value. The functionality of the StreamSale Distribution Model allows the consumer to feel as if they are being given a gift for something they normally pay for in and of itself, while utilizing a new service offered to the fan, as a way to actually purchase the album. The StreamSale Distribution Model offers an entirely new business function, offering a new service while securing the same end-result.

The StreamSale Distribution Model offers the consumer a pay-per-stream interactive online experience that they will, in return for payment of services and product, receive via physical mail, a copy of the album. This will happen on or before the day it is released to the general public. The pay-per-stream experience will allow the consumer a first of its kind live feed, of actual recording sessions and concerts, featuring their favorite artists recording or performing the album they will receive for purchase. When the consumer registers and pays for the service, we will ask each one the following question:
“By purchasing this StreamSale Internet experience, you are receiving the completed album via physical mail on or before the day of public release. As a result, we will track the sale of this service as one trackable album sale for Music Industry purposes. Do you agree?”.
   By offering a live streaming experience where fans can observe the recording process first hand, or a concert they could have never attended, they are actually paying for a service that is replacing the current method to sell the album. This is the exact function of this new business model. The consumer is paying for one service (the Internet Streaming Experience). However, as part of the purchase, they are receiving an additional product (the Album), which has traditionally been directly paid for by the consumer. No other business transaction serves this purpose or satisfies this result. Traditional methods of album sales will continue, where The StreamSale Distribution Model will generate its own revenue in the Music Industry, eventually replacing the need to sell the album itself. This is the unique and original method of The StreamSale Distribution Model.

### PRINCIPLE FUNCTION OF THE INVENTION

This model does not claim ownership of streaming the live interactive experience of the recording session, broadcasting a concert performance on the Internet, or utilizing an album as a promotional product. The claim is the utilization of this Internet streaming experience as a business model of particular functionality to generate profit for the artist's album by including the sale of the album as a paying to view the live StreamSale streaming experience. Artists, businesses, individuals, whomever, are all still welcome to broadcast live video streaming events as they do now. However, the StreamSale Distribution Model is the only one that is able to attach the sale of the album itself to the experience of the streaming broadcast via the Internet. While some companies may charge to view the broadcast of a concert, we are charging for the experience of viewing the live event to receive the album. The function of the consumer paying for the streaming experience to receive the album is the claim. This serves in maintaining, and actually securing the Industry need to track and chart album sales. The StreamSale Method will ensure the artist's right to the exact monies they traditionally received from album sales. Without selling a single album and actually offering the album as a promotional product, while ensuring the same profit and album tracking needs; the StreamSale Distribution Model creates a one-of-a-kind business model that will rescue and revolutionize the functionality of a multi-billion dollar a year industry.

What I claim is:

1. A method comprising:
receiving information corresponding to a request by a user;
responsive to receiving the information, providing the user with access to live video streams corresponding to at least one music performance involving a music performer, said music performance being prior to a public release of a music album corresponding to the performer; and responsive to receiving the information, providing the user with the music album after providing the user with access to the live video streams.

2. The method of claim 1, wherein the request is for a subscription for accessing the live video streams.

3. The method of claim 1, wherein the music performance is for a recording session for a song in the music album.

4. The method of claim 1, wherein the music performance is a concert performance involving the performer.

5. The method of claim 1, wherein the music album is provided to the user for free.

6. The method of claim 1, wherein providing access to the live video stream and providing the music album are in exchange for single payment by the user.

7. The method of claim 1, wherein the music album is provided to the user via a portable physical storage medium.

8. The method of claim 7, wherein the portable physical storage medium is one of a compact disc (CD) and a digital versatile disc (DVD).

9. The method of claim 1, wherein the music performance is prior to the completion of the music album.

10. The method of claim 1, wherein the information corresponding to the request includes payment and address information corresponding to the user.

11. The method of claim 1, wherein the user is provided with the music album prior to the music album becoming available to the general public.

12. The method of claim 1, wherein the user is provided with access to a plurality of video streams corresponding to a plurality of respective cameras at the music performance.

13. The method of claim 1, wherein the user is provided with access to the video streams responsive to the user providing log-in and password information.

14. Software configured to enable the method of claim 1.

15. A method comprising:
providing a user with a subscription entitling the user to access live video streams corresponding to at least one music performance involving a music performer, said music performance being prior to a public release of a music album corresponding to the performer; and
providing the user with the music album responsive to providing the user with the subscription.

16. The method of claim 15, wherein the music performance is for a recording session for a song in the music album.

17. The method of claim 15, wherein the music performance is a concert performance involving the performer.

18. The method of claim 15, wherein the music album is provided to the user for free.

19. The method of claim 15, wherein providing access to the live video stream and providing the music album are in exchange for single payment by the user.

20. The method of claim 15, wherein the music album is provided to the user via a portable physical storage medium.
